(19) United States
(12) Patent Application Publication
(10) Pub. No.: US 2019/0003920 A1
(43) Pub. Date: Jan. 3, 2019

(54) VISUALIZATION OF MULTI-PIPE INSPECTION RESULTS

(71) Applicant: Halliburton Energy Services, Inc., Houston, TX (US)

(72) Inventors: Reza Khalaj Amineh, Houston, TX (US); Burkay Donderici, Pittsford, NY (US); Luis Emilio San Martin, Houston, TX (US)

(21) Appl. No.: 16/066,461

(22) PCT Filed: Mar. 9, 2016
(86) PCT No.: PCT/US2016/021488

§ 371 Date: Jun. 27, 2018

(51) Int. Cl. G01M 3/40; G06T 15/00

(52) U.S. Cl. CPC G01M 3/40; G06T 15/005

(57) ABSTRACT

Apparatus and methods to visualize pipes of a multi-pipe structure associated with a well site can be implemented in a variety of applications. Responses acquired from signals received in response to transmission of a probe signal from a transmitter operatively disposed within the multi-pipe structure may be processed to determine regions of equivalent metal loss in the pipes. In response to processing the responses, a visualization of the pipes, including defects, may be generated. Additional apparatus, systems, and methods are disclosed.

### TECHNICAL FIELD

The present invention relates generally to apparatus and methods with respect to measurements related to oil and gas exploration.

### BACKGROUND

Monitoring the condition of production tubing, different casing strings, joints, collars, filters, packers and perforations is crucial in oil and gas field operations. Electromagnetic (EM) techniques are common means to evaluate these components. EM sensing provides continuous, in situ measurements of the integrity of tubing/casing. EM technologies developed for such monitoring applications can be categorized into two groups: frequency-domain techniques and time-domain techniques. The usefulness of such measurements may be related to the precision or quality of the information and the presentation of the data derived from such measurements.

### BRIEF DESCRIPTION OF THE DRAWINGS

FIG. 1 is a schematic diagram of a transmitter and a receiver in a multi-pipe structure, in accordance with various embodiments.

FIG. 2A is a schematic diagram of a transmitter and receiver in a multi-pipe structure, in accordance with various embodiments.

FIG. 2B is a plot of inversion results presented as a well diagram, in accordance with various embodiments.

FIG. 3A is a schematic diagram of a transmitter and receiver in a multi-pipe structure, in accordance with various embodiments.

FIG. 3B is a plot of the inspection results as top-view cross section images, in accordance with various embodiments.

FIG. 4A is a schematic diagram of a transmitter and receiver in a multi-pipe structure, in accordance with various embodiments.

FIG. 4B is a plot of inspection results as images, in accordance with various embodiments.

FIG. 5A is a schematic diagram of a transmitter and receiver in a multi-pipe structure, in accordance with various embodiments.

FIG. 5B is a plot representing inspection results like a borehole image, in accordance with various embodiments.

FIGS. 6A-C are plots of inspection results as 3D plots, in accordance with various embodiments.

FIG. 7 is a flow diagram of features of a method to visualize inspection of a multi-pipe structure, in accordance with various embodiments.

FIG. 8 is a block diagram of features of an example system operable to execute schemes associated with visualization of multi-pipe inspection data, applications of the visualization, and combinations thereof, in accordance with various embodiments.

### DETAILED DESCRIPTION

The following detailed description refers to the accompanying drawings that show, by way of illustration and not limitation, various embodiments in which the invention may be practiced. These embodiments are described in sufficient detail to enable those skilled in the art to practice these and other embodiments. Other embodiments may be utilized, and structural, logical, and electrical changes may be made to these embodiments. The various embodiments are not necessarily mutually exclusive, as some embodiments can be combined with one or more other embodiments to form new embodiments. The following detailed description is, therefore, not to be taken in a limiting sense.

Since EM sensing can provide continuous, in situ measurements of the integrity of tubing/casing, there has been considerable interest in using EM in cased borehole monitoring applications. However, the available tools commonly do not employ elaborate visualization of the results for the evaluation of multiple pipes. One corrosion inspection tool, for example, provides estimates of the total thickness of the casings, employing multiple frequency-domain data acquisitions and interpretations and using an inversion process. However, it has not been tailored for the evaluation of individual casings. Other corrosion inspection tools analyze the time-domain decay response to characterize the tubing plus casing, with an inversion process based on comparison of measured response with simulated responses in a library for pre-known casings. The final results of these tools are in the form of estimated thickness values for these two pipes.

Detailed visualization of inspection results helps in more accurate evaluation of the pipes that, in turn, leads to more appropriate decisions about the condition of the pipes. The ultimate goal is to have a proper assessment of the condition of the pipes so that repair or replacement strategies can be implemented in a timely manner. In conventional methods of showing inspection results, the estimated thicknesses for each pipe typically are plotted versus the depth.

Herein, various approaches are disclosed that can be employed to visualize the responses in multiple-pipe inspection scenarios. Such visualization approaches can include, but are not, limited to (i) plotting the results as a well diagram (side-look), (ii) plotting the results as top-view cross section images, (iii) plotting the results as color images. (iv) plotting the results like a borehole image where features on different pipes appear as different colors, different shadings, or side by side, and (v) plotting the results as three-dimensional (3D) plots.

Herein, a multi-pipe structure is a structure having a set of two or more pipes nested within each other, the set having an innermost pipe and an outermost pipe, where the innermost pipe has the smallest outer diameter of the pipes of the set, the outermost pipe has the largest outer diameter of the pipes of the set, and the remaining pipes of the set have outer diameters of value greater than the value of the outer diameter of the innermost pipe and less the than the value of the outer diameter of the outermost pipe with each pipe of the set having a different outer diameter with respect to the other pipes of the set. At a point on a reference axis within the innermost pipe of the set in the longitudinal direction of the innermost pipe, a plane perpendicular to the reference axis intersects the pipes of the multi-pipe structure. In various embodiments, a multi-pipe structure can be realized by a set of concentric pipes. However, a multi-pipe structure is not limited to a set of concentric pipes.

In various embodiments, processes can be employed to visualize results of the multi-pipe inspection. Such processes may be implemented to provide the maximum possible information regarding the details of the characterization of the pipes. In a multiple-pipe inspection process, one or more these processes may be employed in a variety of combinations to visualize the conditions of the pipes.

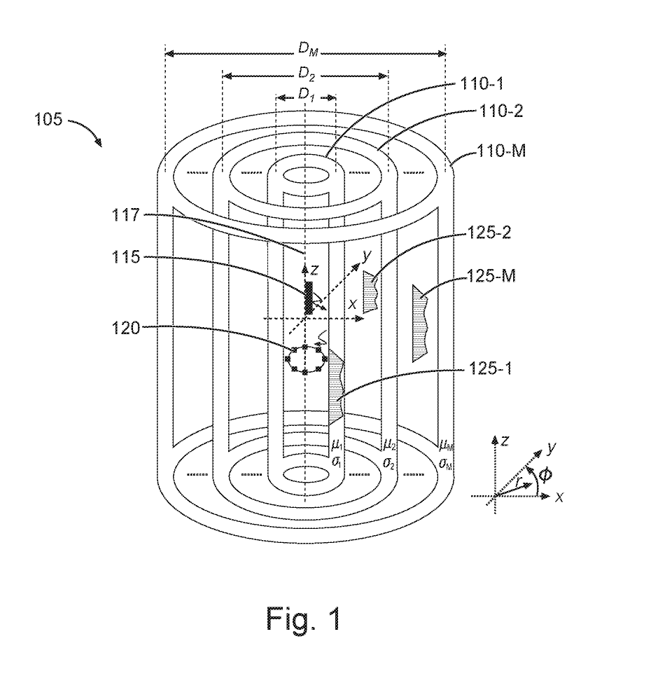

FIG. 1 is a schematic diagram of a transmitter 115 and a receiver 120 in a multi-pipe structure 105. The multi-pipe structure 105 may include pipes 110-1, 110-2 . . . 110-M. Though, FIG. 1 shows three pipes (M=3), the multi-pipe structure 105 may include more or less than three pipes. Pipe 110-1 has a diameter, D₁, a magnetic permeability, μ₁, and electrical conductivity, σ₁. Pipe 110-2 has a diameter D₂, a magnetic permeability, μ₂, and electrical conductivity, σ₂. Pipe 110-M has a diameter D_{M}, a magnetic permeability, μ_{M}, and electrical conductivity, σ_{M}. Each of the pipes of the multi-pipe structure 105 may include one or more defects at different depths. A defect may be a void, corrosion, or combinations thereof. As a non-limiting example, FIG. 1 shows pipe 110-1 with defect 125-1, pipe 110-2 with defect 125-2, and pipe 110-M with defect 125-M. The transmitter 115 and a receiver 120 can be operated to inspect the pipes of the multi-pipe structure 105 to determine if each of the pipes has defects and to visualize the results of the inspection of the multi-pipe structure 105.

Responses can be acquired from signals received from the pipes 110-1, 110-2, . . . 110-M of the multi-pipe structure 105 in response to transmission of a probe signal from the transmitter 115 operatively disposed within the multi-pipe structure 105. An inversion operation can be executed to operate on these responses. The dimensions of defects in the pipes 110-1, 110-2 . . . 110-M of the multi-pipe structure 105 can be estimated from the responses by employing a proper inversion algorithm. Inversion is a process of searching for a match between simulated data and measurements. Inversion operations can include a comparison of measurements to predictions of a forward model such that a value or spatial variation of a physical property can be determined. A forward model deals with calculating expected observed values with respect to an assumed model of formation with associated formation properties.

The transmitter 115 is an excitation source that may include one or more transmitting devices. The receiver 120 may be structured as an array of receiving sensors. The receiver 120 may include an azimuthally distribution sensor array. The transmitter 115 and the receiver 120 may be realized by one or more types of electromagnetic sensors or magnetic sensors. The transmitter 115 and the receiver 120 may be arranged to probe the pipes 110-1, 110-2 . . . 110-M with the transmitter 115 and the receiver 120 disposed within the innermost pipe 110-1. Alternatively, the transmitter 115 and the receiver 120 may be arranged within a pipe different from the innermost pipe 110-1. The transmitter 115 and the receiver 120 can be moved along a longitudinal axis 117 of innermost pipe 110-1 to make measurements at different depths. Movement along the longitudinal axis 117 may be conducted within the multi-pipe structure 105 parallel to longitudinal axis 117. Alternatively, the transmitter 115 and the receiver 120 may be realized as a number of transmitters and receivers within the multi-pipe structure 105 disposed at different depths from the earth's surface.

With the receiver 120 realized as an azimuthally distribution sensor array, the sensors of the azimuthally distribution sensor array may be uniformly placed at equal angles in a plane forming a loop. The loop can be formed around the longitudinal axis 117. Alternatively, the sensors of the azimuthally distribution sensor array may be arranged at different angles from one sensor to its adjacent sensor.

A probe signal may be sent out from the transmitter 115. The characteristics of the signals reflected back from pipes 110-1, 110-2, . . . 110-M of multi-pipe structure 105 can be based on the properties of the pipes 110-1, 110-2, . . . 110-M. A defect in a pipe in most cases can have properties such as magnetic permeability and electrical conductivity that are different from the non-defect portion of the pipe. Measurement of these signals can be processed to derive metal loss of each of the pipes 110-1, 110-2 . . . 110-M. The signals reflected from the walls of the pipes can be processed to provide a visualization or image of the pipes, in which the regions between the walls of the pipes are background regions that are effectively transparent.

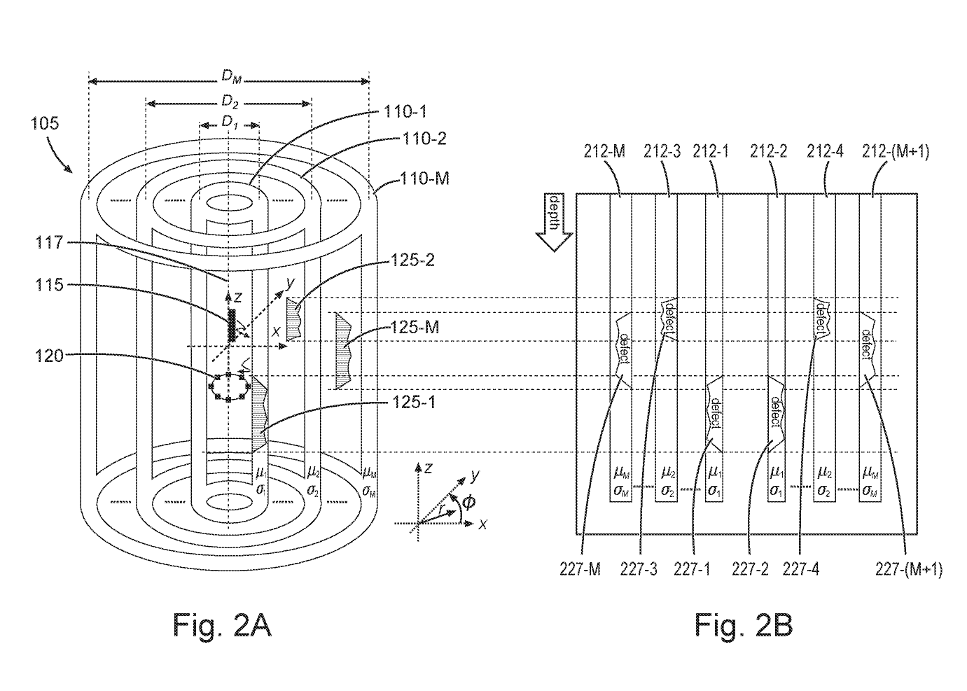

FIG. 2A is a schematic diagram of a transmitter and receiver in a multi-pipe structure. FIG. 2A reproduces the schematic diagram of FIG. 1 to provide context to the plot shown in FIG. 2B. Responses can be acquired from signals received from pipes 110-1, 110-2, . . . 110-M of the multi-pipe structure 105 in response to transmission of a probe signal from the transmitter 115 operatively disposed within the multi-pipe structure 105. An inversion operation can be executed to operate on these responses. The dimensions of defects in the pipes 110-1, 110-2 . . . 110-M of the multi-pipe structure 105 can be estimated from the responses by employing a proper inversion algorithm.

FIG. 2B is a plot of inversion results presented as a well diagram. In such a well diagram, the inversion results for the pipes 110-1, 110-2 . . . 110-M of the multi-pipe structure 105 are shown in a side-look format. This visualization can be at any desired azimuthal angle. One or more images may be generated for each angle. With the dimensions of defects estimated from the responses by employing a proper inversion algorithm, at any desired azimuthal angle, the cross sections of the walls of the pipes 110-1, 110-2 . . . 110-M can be illustrated on a two-dimensional (2D) plane along the axial and radial directions. Pipe 110-1 is shown with respect to cross sections 212-1 and 212-2 with defects 227-1 and 227-2, respectively. Pipe 110-2 is shown with respect to cross sections 212-3 and 212-4 with defects 227-3 and 227-4, respectively. Pipe 110-M is shown with respect to cross sections 212-M and 212-(M+1) with defects 227-M and 227-(M+1), respectively. The format of the illustration can be such that the color of the defected region is different from the color of the pipe wall. The thickness of nominal sections (sections without defects) of the pipes can be obtained through the inversion algorithm or can be obtained from a priori information regarding the pipes.

In this format of illustrating defects, it is possible to show an equivalent metal loss region computed for all azimuthal directions on an image created at a single azimuthal angle. Also, each pipe of the multi-pipe structure 105 may be shown in a separate window. Each pipe can be illustrated in a 2D view along the axial and radial directions at a fixed azimuthal angle, or it can be shown in a 3D view, where the pipe wall and the defects are shown with suitable colors and shadings to illustrate the extent of the defects in various directions.

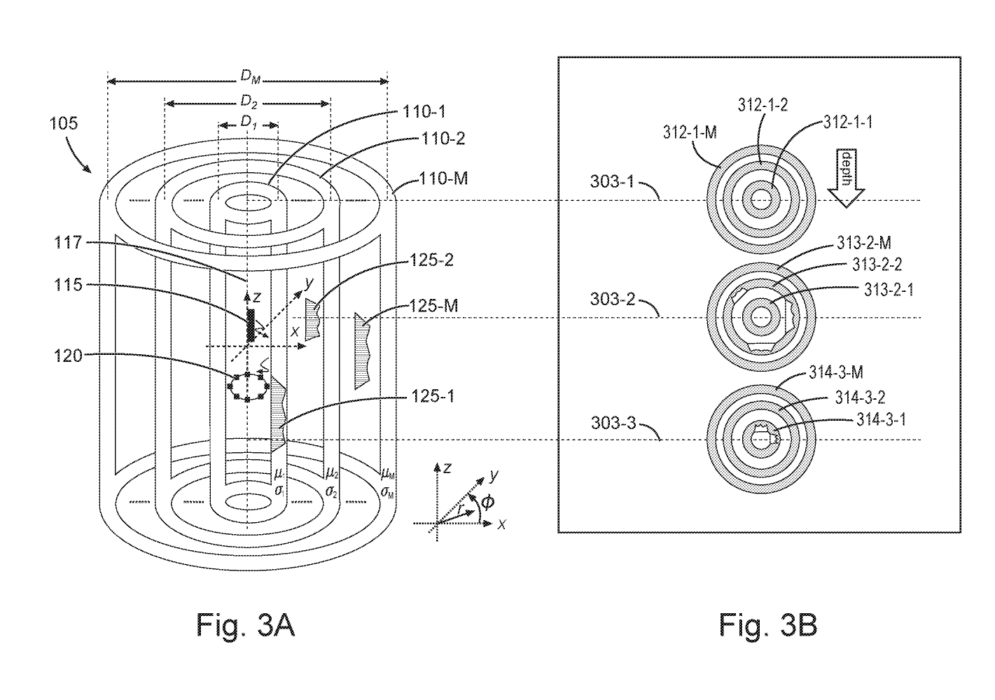

FIG. 3A is a schematic diagram of a transmitter and receiver in a multi-pipe structure. FIG. 3A reproduces the schematic diagram of FIG. 1 to provide context to the plot shown in FIG. 3B. Responses can be acquired from signals received from the pipes 110-1, 110-2, . . . 110-M of the multi-pipe structure 105 in response to transmission of a probe signal from the transmitter 115 operatively disposed within the multi-pipe structure 105. An inversion operation can be executed to operate on these responses. The dimensions of defects in the pipes 110-1, 110-2 . . . 110-M of the multi-pipe structure 105 can be estimated from the responses by employing a proper inversion algorithm.

FIG. 3B is a plot of the inspection results as top-view cross section images. Images of the cross section of the pipes 110-1, 110-2, . . . 110-M are shown at each selected position 303-1, 303-2, and 303-3 along the axial direction of the multi-pipe structure 105. The images can show rings 312-1-1, 312-1-2, and 312-1-M at axial position 303-1, rings 312-2-1, 312-2-2, and 312-2-M at axial position 303-2, and rings 312-3-1, 312-3-2, and 312-3-M at axial position 303-3 corresponding to the pipes 110-1, 110-2, . . . 110-M with the thickness of each ring representing the thickness of each pipe. Defects are shown on these rings with their respective size and position obtained from the use of a proper inversion technique. The format of the illustration can be such that the color of the defected region is different from the color of the pipe wall. A 2D cross section image may be generated to show only a single pipe or to show multiple pipes. The format of the illustration can be such that the color of the defected region can be different from the color of the pipe wall. The thickness of nominal sections of each of the pipes 110-1, 110-2 . . . 110-M can be obtained through the inversion algorithm or can be obtained from a priori information regarding the pipes.

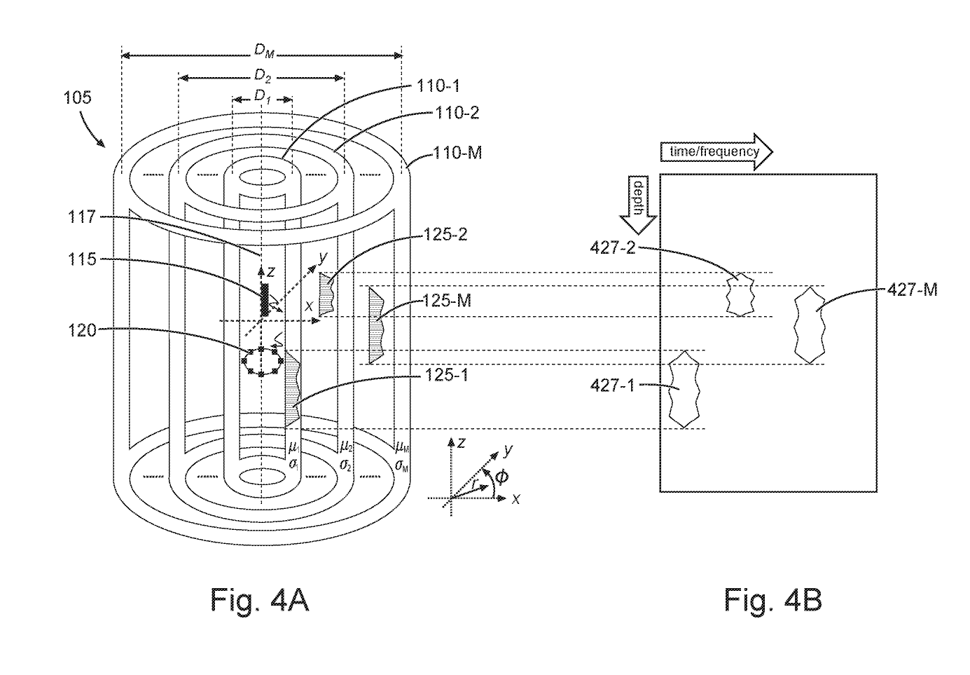

FIG. 4A is a schematic diagram of a transmitter and receiver in a multi-pipe structure. FIG. 4A reproduces the schematic diagram of FIG. 1 to provide context to the plot shown in FIG. 4B. Responses can be acquired from signals received from pipes 110-1, 110-2, . . . 110-M of the multi-pipe structure 105 in response to transmission of a probe signal from the transmitter 115 operatively disposed within the multi-pipe structure 105. An inversion operation can be executed to operate on these responses. The dimensions of defects in the pipes 110-1, 110-2 . . . 110-M of the multi-pipe structure 105 can be estimated from the responses by employing a proper inversion algorithm.

FIG. 4B is a plot of inspection results as images. In this method of visualization, images can be constructed based on the values of the measured responses. This method can be adapted for time-domain or frequency-domain techniques. In the time-domain technique, the image can be computed based on the ratio between the measured response for the defected region (427-1, 427-2, 427-M) and the response for the nominal (non-defected) region. This procedure can be implemented at each depth and over the whole response time. The values of this ratio can then be plotted versus time with proper colors or grey levels (in grey scale image format) to construct images. Alternatively, the difference between the measured response for the defected region (427-1, 427-2, 427-M) and the response for the nominal (non-defected) region versus time at all depths can be considered for constructing the images. In such images, the defects appear as non-uniformities in the background color or grey scale levels. The defects on the outer pipes appear in later response times.

In the frequency-domain technique, the image can be computed, similar to the time-domain technique, based on the ratio between the measured response at the defected region and the nominal (non-defected) region. This procedure can be implemented at each depth and over all the measurement frequencies. Similar to the time-domain technique, the difference between the response for a defected region and the response for the nominal region versus frequency at all depths can be considered for the construction of images. Then, in the constructed image, the values of this ratio can be plotted versus frequencies with proper colors or grey levels (in grey scale image format). Similar to the images constructed in the time-domain technique, the defects appear as non-uniformities in the background color or grey scale levels. The defects on the outer pipes may appear only at lower frequencies, while the defects on inner pipes appear at both the higher and lower frequencies.

Signals may be analyzed over intervals of time and/or frequency. From the analysis, features such as defects can be correlated to their respective pipes. Such correlation can also attributed to specific angles relative to a reference.

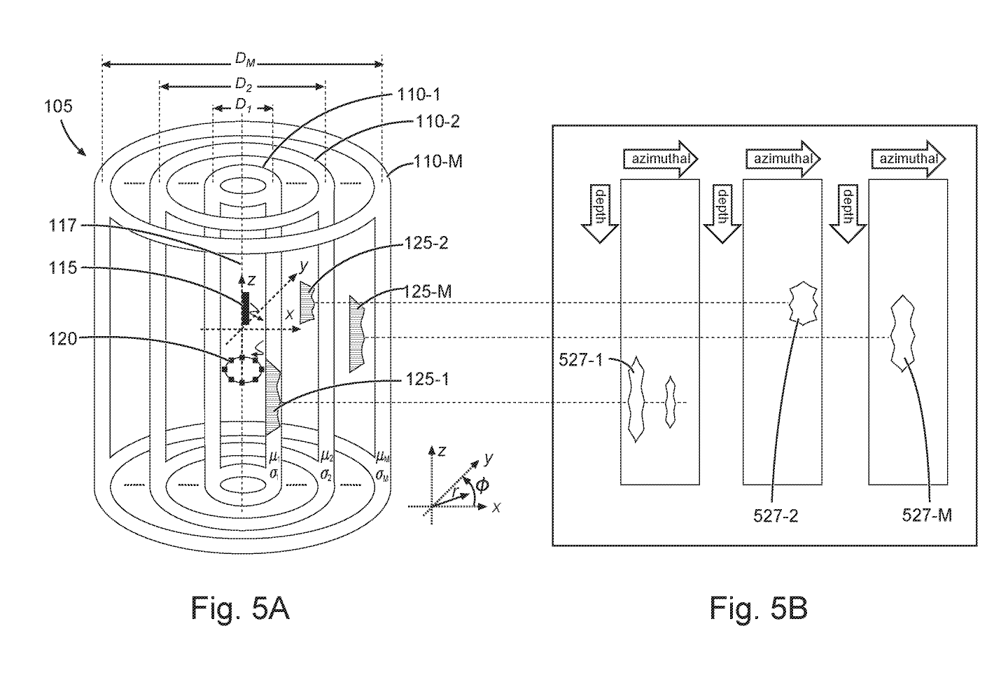

FIG. 5A is a schematic diagram of a transmitter and receiver in a multi-pipe structure. FIG. 5A reproduces the schematic diagram of FIG. 1 to provide context to the plot shown in FIG. 5B. Responses can be acquired from signals received from pipes 110-1, 110-2, . . . 110-M of the multi-pipe structure 105 in response to transmission of a probe signal from the transmitter 115 operatively disposed within the multi-pipe structure 105. An inversion operation can be executed to operate on these responses. The dimensions of defects in the pipes 110-1, 110-2 . . . 110-M of the multi-pipe structure 105 can be estimated from the responses by employing a proper inversion algorithm.

FIG. 5B is a plot representing inspection results like a borehole image. In this method of visualization, 2D images of the pipes can be constructed along the axial and azimuthal directions for each pipe. The images can be constructed for each pipe separately or they can be merged into a single image, where the features of each pipe are shown by a different color. In each 2D image, the values of the ratio, or values of the difference, between the measured response at the defected region and the nominal (non-defected) region can be plotted in color-coded or grey scale formats. Alternatively, the features on the pipes (such as defects 527-1, 527-2, 527-M) can be shown with contours showing the boundaries of the defected regions. Another way of showing the images is to construct a pseudocolor image. In this pseudocolor image, each set of four adjacent points in the image matrix is used to define the image value at each pixel. Colors can be assigned according to thickness of the metal. The color assignment can be local, for instance for a detailed view to enhance local features, or global for a view of large sections of the pipes or entire pipes.

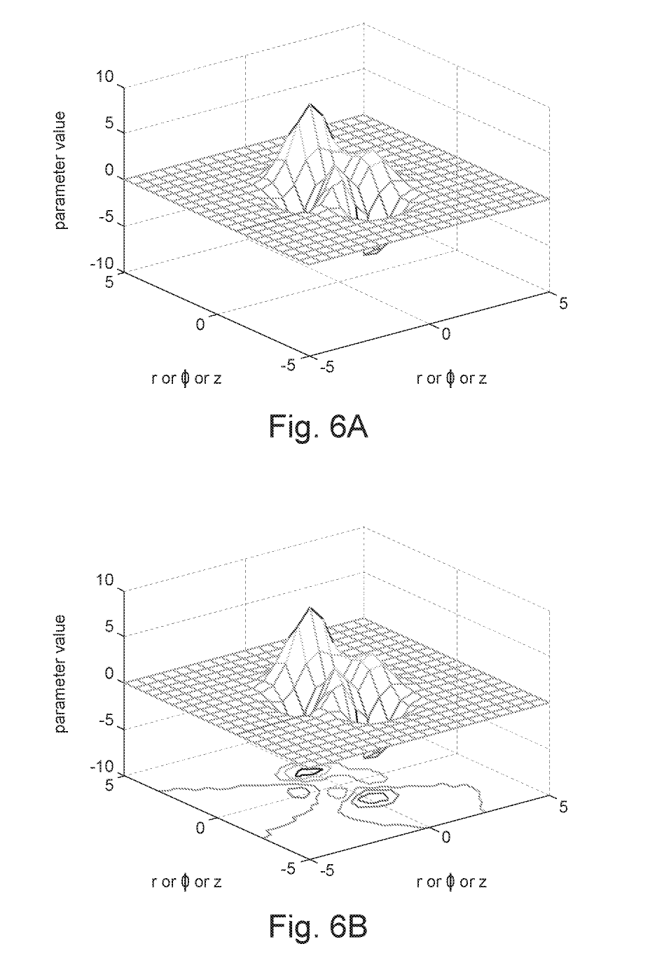

FIGS. 6A-C are plots of inspection results as 3D plots. The inspection results in the form of responses or inversion results can be shown in 3D plots as shown in FIG. 6A-C. These plots can be a representation of values versus spatial directions. Table 1 shows possible quantities for various axes in this visualization format of 3D plots. The values in these plots may be shown in a colored wireframe mesh with colors being proportional to surface height. FIG. 6A represents a plot with respect to a wireframe mesh. FIG. 6B represents a plot with respect to a wireframe mesh with contours. FIG. 6C represents a plot with respect to a wireframe mesh with contours and shading. Contours also can be shown under the 3D plot in a 2D plane in the same overall plot with the 3D plot. Proper shadings can also be used in these plots. Though not shown in FIGS. 6A-6C, the wireframe mesh can be displayed as a colored wireframe mesh, and curves on and below the wireframe mesh can be displayed in a color format.

TABLE 1

| | POSSIBLE QUANTITIES | POSSIBLE QUANTITIES |
|---|---|---|
| | (Cylindrical coordinate | (Cartesian coordinate |
| AXIS | system) | system) |
| x | r (should non-negative value) | x |
| | φ | y |
| | z | z |
| y | r (should non-negative value) | x |
| | φ | y |
| | z | z |
| z | inversion results or processed | inversion results or processed |
| | response values | response values |

In various embodiments, 3D printing of real size or scaled models can be implemented based on the visualizations generated. In cases that may implement detailed visualization, when planning a remedial intervention for example, it may be convenient to create real size or scaled models of the section of interest. In such cases, the data obtained from the inversion data can be used to print a 3D realization of the pipe thicknesses of the section of interest.

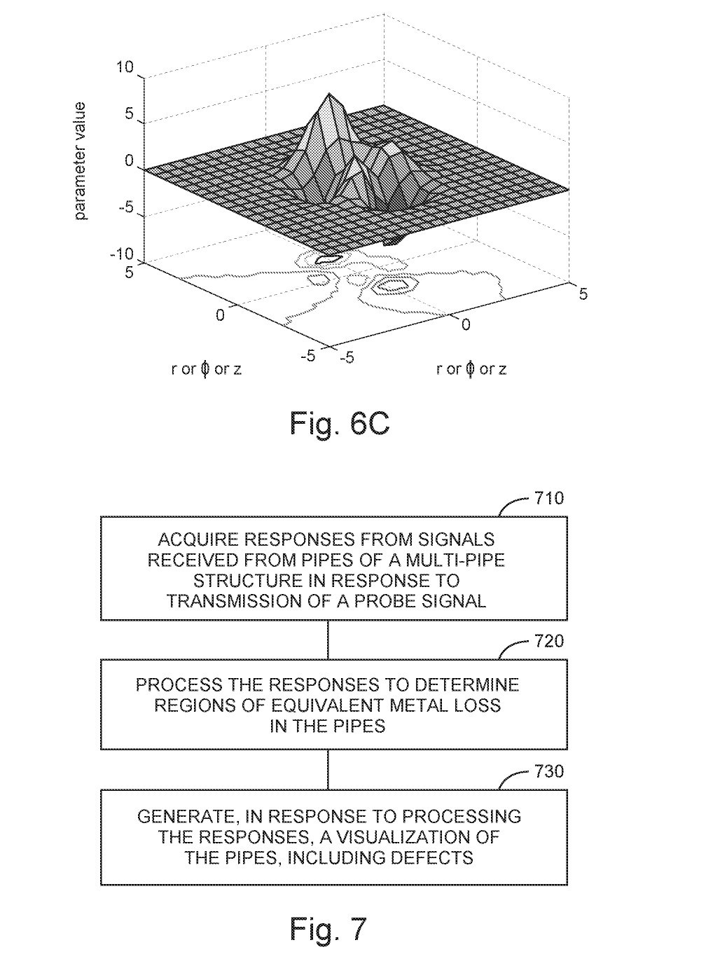

FIG. 7 is a flow diagram of features of a method 700 to visualize inspection of a multi-pipe structure. At 710, responses are acquired from signals received from pipes of a multi-pipe structure in response to transmission of a probe signal. The probe signal can be generated from a transmitter operatively disposed within the multi-pipe structure. At 720, the responses are processed to determine regions of equivalent metal loss in the pipes. At 730, in response to processing the responses, one or more visualizations of the pipes, including defects, is generated. The visualization can be based on the responses or on results from an inversion operation on the responses. The one or more visualizations can be selected from a group of visualizations including a plot of top-view cross section images of one or more pipes correlated to a position of a set of positions along an axial direction, a plot as images with respect to frequency or time and depth, a set of plots of images with each plot being an image of a different pipe along the axial and azimuthal directions for each pipe, and one or more three-dimensional plots of parameter values with respect to a radial direction or an azimuth or depth. Method 700 or methods similar or identical to method 700 can include analyzing data associated with the visualization of the pipes and generating an action plan to remediate the multi-pipe structure based on the analysis.

The multi-pipe structure may be composed of three pipes. The multi-pipe structure may be composed of four or more pipes. The responses can be frequency domain responses with respect to amplitude, phase, attenuation, or phase difference. The responses can be time domain responses with respect to amplitude or attenuation.

The generation of the one or more visualizations of the pipes may be realized in one or more formats. The visualizations can include plotting the inversion results as two-dimensional images showing the pipes and pipe features along two spatial directions. Methods such as method 700 or similar methods can include generating a visualization of the pipes as a plot of results of the inversion operation on the responses, in which dimensions of the pipes are estimated from the results of the inversion operation, with cross sections of walls of the pipes displayed on a two-dimensional plane along axial and radial directions with respect to an axis of the pipes.

Selected visualizations of the pipes in methods such as method 700 or similar methods can include a plot of top-view cross section images of one or more pipes correlated to a position of a set of positions along an axial direction. Generating the top-view cross section images of the one or more pipes can include generating the top-view cross sections of the pipes as rings at selected depths with thickness of each ring representing thickness of each pipe and with the one or more detected defects shown on the rings with respective size and position obtained from the inversion operation.

Selected visualizations of the pipes in methods such as method 700 or similar methods can include a plot as images with respect to frequency or time and depth. Generating the plot as images with respect to frequency and depth can include computing images for each pipe based on a ratio or difference between acquired responses of a region of a defect of the respective pipe and acquired response of a region of non-defect of a respective pipe, implemented at each depth and over measurement frequencies. The one or more detected defects cam be imaged as non-uniformities in background color or background grey scale levels.

Selected visualizations of the pipes in methods such as method 700 or similar methods can include a set of plots of images with each plot being an image of a different pipe along the axial and azimuthal directions for each pipe. The images can be constructed for each pipe separately or the images can be merged into a single image with features of each pipe shown by a different color. Each image may be a two-dimensional image based on values of a ratio or a difference between the acquired response at a defected region and a non-defected region plotted in color-coded or grey scale format. Methods such as method 700 or similar methods can include assigning, in each image of a different pipe, a color to the one or more detect defects in the respective pipe based on thickness of a non-defected region of the respective pipe. Methods such as method 700 or similar methods can include imaging the one or more detected defects in a respective pipe of the multi-pipe structure using a set of four adjacent points in an image matrix to define an image value at each pixel.

Selected visualizations of the pipes in methods such as method 700 or similar methods can include one or more three-dimensional plots of parameter values with respect to a radial direction or an azimuth or depth. Generating the one or more three-dimensional plots can include plotting the parameter values in a colored wireframe mesh.

Selected visualizations of the pipes in methods such as method 700 or similar methods can include generating images of the pipes in a color or shading different from a color generated for walls of the pipes. Generating the one or more visualizations can include generating images of the pipes in a color or shading for each pipe different from color or shading for the other pipes of the multi-pipe structure.

Methods such as method 700 or similar methods can include analyzing data associated with the one or more visualizations of the pipes and generating an action plan to remediate the multi-pipe structure based on the analysis. In various embodiments, a machine-readable storage device can have instructions stored thereon, which, when executed by one or more processors of a machine, cause the machine to perform operations, the operations comprising any of the features of methods to visualize inspection of a multi-pipe structure, and conducting operations based on the visualization and/or inspection results and processing in a manner identical to or similar to the methods and schemes described herein. The operations can include acquiring responses from signals received from pipes of a multi-pipe structure in response to transmission of a probe signal from a transmitter operatively disposed within the multi-pipe structure; processing the responses to determine regions of equivalent metal loss in the pipes; and generating, in response to processing the responses, one or more visualizations of the pipes, including one or more detected defects, based on the responses or on results from an inversion operation on the responses, the one or more visualizations selected from a group of visualizations including a plot of top-view cross section images of one or more pipes correlated to a position of a set of positions along an axial direction, a plot as images with respect to frequency or time and depth, a set of plots of images with each plot being an image of a different pipe along the axial and azimuthal directions for each pipe, and one or more three-dimensional plots of parameter values with respect to a radial direction or an azimuth or depth.

The operations can include operations to conduct any one of the methods as taught herein. The operations can include operations to control a source to generate the probe signal and to control a receiver to receive the signals from the pipes, the source and receiver arranged to operate from within the multi-pipe structure. The operations can include operations to control the receiver structured as an azimuthally distributed sensor array. Further, a machine-readable storage device, herein, is a physical device that stores data represented by physical structure within the device. Examples of machine-readable storage devices include, but are not limited to, read only memory (ROM), random access memory (RAM), a magnetic disk storage device, an optical storage device, a flash memory, and other electronic, magnetic, and/or optical memory devices.

A system can comprise: one or more processors, a memory module operable with the one or more processors, wherein the one or more processors and the memory module are structured to operate to: acquire responses from signals received from pipes of a multi-pipe structure in response to transmission of a probe signal from a transmitter operatively disposed within the multi-pipe structure; process the responses to determine regions of equivalent metal loss in the pipes; and generate, in response to processing the responses, one or more visualizations of the pipes, including one or more detected defects, based on the responses or on results from an inversion operation on the responses, the one or more visualizations selected from a group of visualizations including a plot of top-view cross section images of one or more pipes correlated to a position of a set of positions along an axial direction, a plot as images with respect to frequency or time and depth, a set of plots of images with each plot being an image of a different pipe along the axial and azimuthal directions for each pipe, and one or more three-dimensional plots of parameter values with respect to a radial direction or an azimuth or depth; and a display to display the visualization.

Such a system can include a user interface operable with the one or more processors to generate and control the visualization. Such a system can include a source to generate the probe signal and a receiver to receive the signals from the pipes, the source and receiver arranged to operate from within the multi-pipe structure. The receiver can include an azimuthally distributed sensor array or an azimuthally symmetric receiver. In such a system, the display can include a touch screen. The system can include a computer mouse operable with the user interface to provide user inputs used in the operation of the excitation source and receiver sensors and imaging of the inspection data.

In various embodiments, the one or more processors and the memory module can be structured to generate one or more visualizations from a group of visualizations including a plot of the responses or the results from the inversion operation as a well diagram having a side-look, a plot of the responses or the results from the inversion operation as top-view cross section images, a plot of the responses or the results from the inversion operation as color images, a plot of the responses or the results from the inversion operation with features on different pipes represented as different colors, different shadings, a side by side view, or a combination of different colors, different shadings, and a side by side view, and a plot of the responses or the results from the inversion operation as three-dimensional plots.

Such systems and methods can be implemented with user interfaces, which can provide a device that allows user interaction. A user interface can include a display unit and underlining electronics that allow input and output of signals associated with managing and providing data to the display unit. A user interface can be interactive providing a mechanism for input from a user, which may be in response to information displayed to the user by the user interface. A user interface may include hardware and logical components. In such embodiments, a visualization of pipe inspection data may affect the way the data is interpreted. In addition, providing images of the pipes in the multi-pipe structure in different visualizations can help a user identify and respond to any problems that may be encountered in the multi-pipe structure of a production well in a quick and effective manner.

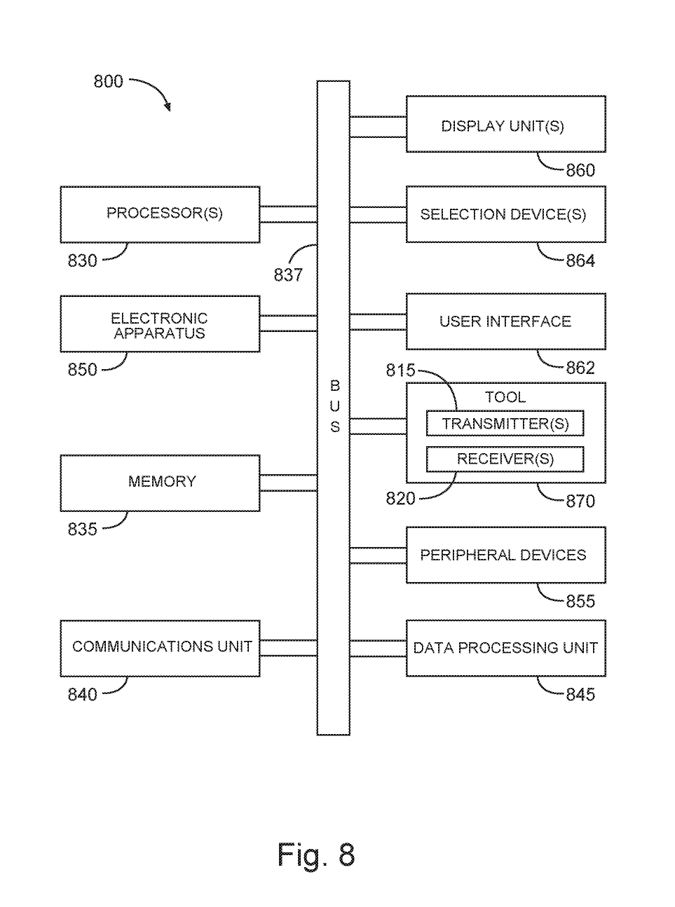

FIG. 8 is a block diagram of features of an embodiment of an example system 800 operable to execute schemes associated with visualization of data, applications of the visualization, and combinations thereof. System 800 can include one or more processors 830, a user interface 862 operable with the one or more processors 830, a data processing unit 845 operable with the user interface 862, where the one or more processors 830, the user interface 862, and the data processing unit 845 are structured to be operated according to any scheme similar to or identical to the schemes associated with visualization of data, application of the visualization, and combinations thereof as taught herein. In an embodiment, processor(s) 830 can be realized as a single processor or a group of processors. Processors of the group of processors may operate independently depending on an assigned function. The system 800 can be arranged to perform various operations on the data, acquired from a tool 870 operational in a multi-pipe structure, in a manner similar or identical to any of the processing techniques discussed herein. The tool 870 can include a transmitter or transmitters 815 and a receiver or receivers 820.

The system 800 can be arranged as a distributed system and can include components in addition to the one or more processors 830, the user interface 862, and the data processing unit 845. Data from operating the tool 870 at various depths in the multi-pipe structure can be visualized in one format or another by the one or more processors 830, the user interface 862, and the data processing unit 845. Such information may be presented as a visualization with respect to a number of different parameters as taught herein. The data processing unit 845 may be implemented to analyze the visualization to generate quantifications of imaged defects to provide proper remedial actions for the multiple-pipe structure.

The system 800 can include a memory 835, an electronic apparatus 850, and a communications unit 840. The processor(s) 830, the memory 835, and the communications unit 840 can be arranged to operate as a processing unit to control management of tool 870 and to perform operations on data signals collected by the tool 870. The memory 835 can include a database having information and other data such that the system 800 can operate on data from the tool 870. In an embodiment, the data processing unit 845 can be distributed among the components of the system 800 including memory 835 and/or the electronic apparatus 850.

The communications unit 840 can include downhole communications for communication to the surface at a well site from the tool 870 in a multi-pipe structure. Such downhole communications can include a telemetry system. The communications unit 840 may use combinations of wired communication technologies and wireless technologies at frequencies that do not interfere with on-going measurements. The communications unit 840 can allow for a portion or all of the data analysis to be conducted within a multi-pipe structure with results provided to the user interface 862 for presentation on the one or more display unit(s) 860 aboveground. The communications unit 840 can provide for data to be sent aboveground such that substantially all analysis is performed aboveground. The data collected by the tool 870 can be stored with the tool 870 that can be brought to the surface to provide the data to the one or more processors 830, the user interface 862, and the data processing unit 845. The communications unit 840 can allow for transmission of commands to tool 870 in response to signals provided by a user through the user interface 862.

The system 800 can also include a bus 837, where the bus 837 provides electrical conductivity among the components of the system 800. The bus 837 can include an address bus, a data bus, and a control bus, each independently configured. The bus 837 can be realized using a number of different communication mediums that allows for the distribution of components of the system 800. Use of the bus 837 can be regulated by the processor(s) 830. The bus 837 can include a communications network to transmit and receive signals including data signals and command and control signals.

In various embodiments, the peripheral devices 855 can include additional storage memory and/or other control devices that may operate in conjunction with the processor(s) 830 and/or the memory 835. The display unit(s) 860 can be arranged with a screen display, as a distributed component on the surface, that can be used with instructions stored in the memory 835 to implement the user interface 862 to manage the operation of the tool 870 and/or components distributed within the system 800. Such a user interface can be operated in conjunction with the communications unit 840 and the bus 837. The display unit(s) 860 can include a video screen, a printing device, or other structure to visually project data/information. The system 800 can include a number of selection devices 864 operable with the user interface 862 to provide user inputs to operate the data processing unit 845 or its equivalent. The selection device(s) 864 can include one or more of a touch screen or a computer mouse operable with the user interface 862 to provide user inputs to operate the data processing unit 845.

A method 1 can comprise: acquiring responses from signals received from pipes of a multi-pipe structure in response to transmission of a probe signal from a transmitter operatively disposed within the multi-pipe structure; processing the responses to determine regions of equivalent metal loss in the pipes; and generating, in response to processing the responses, one or more visualizations of the pipes, including one or more detected defects, based on the responses or on results from an inversion operation on the responses, the one or more visualizations selected from a group of visualizations including a plot of top-view cross section images of one or more pipes correlated to a position of a set of positions along an axial direction, a plot as images with respect to frequency or time and depth, a set of plots of images with each plot being an image of a different pipe along the axial and azimuthal directions for each pipe, and one or more three-dimensional plots of parameter values with respect to a radial direction or an azimuth or depth.

A method 2 can include elements of method 1 and can include the multi-pipe structure being composed of three pipes.

A method 3 can include elements of methods 1 and can include the multi-pipe structure being composed of four or more pipes.

A method 4 can include elements of any of methods 1-3 and can include the responses being frequency domain responses with respect to amplitude, phase, attenuation, or phase difference.

A method 5 can include elements of any of methods 1-3 and can include the responses being time domain responses with respect to amplitude or attenuation.

A method 6 can include elements of any of methods 1-5 and can include plotting the inversion results as two-dimensional images showing the pipes and pipe features along two spatial directions.

A method 7 can include elements of any of methods 1-6 and can include generating a visualization of the pipes as a plot of results of the inversion operation on the responses, in which dimensions of the pipes are estimated from the results of the inversion operation, with cross sections of walls of the pipes displayed on a two-dimensional plane along axial and radial directions with respect to an axis of the pipes.

A method 8 can include elements of any of methods 1-7 and can include the selected one or more visualizations of the pipes to include a plot of top-view cross section images of one or more pipes correlated to a position of a set of positions along an axial direction.

A method 9 can include elements of any of methods 1-8 and can include generating the top-view cross section images of the one or more pipes of method 8 to include generating the top-view cross sections of the pipes as rings at selected depths with thickness of each ring representing thickness of each pipe and with the one or more detected defects shown on the rings with respective size and position obtained from the inversion operation.

A method 10 can include elements of any of methods 1-9 and can include the selected one or more visualizations of the pipes to include a plot as images with respect to frequency or time and depth.

A method 11 can include elements of any of methods 1-10 and can include generating the plot as images with respect to frequency and depth of claim 10 to include computing images for each pipe based on a ratio or difference between acquired responses of a region of a defect of the respective pipe and acquired response of a region of non-defect of a respective pipe, implemented at each depth and over measurement frequencies.

A method 12 can include elements of any of methods 1-11 and can include the one or more detected defects are imaged as non-uniformities in background color or background grey scale levels.

A method 13 can include elements of any of methods 1-12 and can include the selected one or more visualizations of the pipes to include a set of plots of images with each plot being an image of a different pipe along the axial and azimuthal directions for each pipe.

A method 14 can include elements of any of methods 1-13 and can include the images of method 13 being constructed for each pipe separately or the images are merged into a single image with features of each pipe shown by a different color.

A method 15 can include elements of any of methods 1-14 and can include each image of method 13 being a two-dimensional image based on values of a ratio or a difference between the acquired response at a defected region and a non-defected region plotted in color-coded or grey scale format.

A method 16 can include elements of any of methods 1-15 and can include assigning, in each image of a different pipe of method 13, a color to the one or more detect defects in the respective pipe based on thickness of a non-defected region of the respective pipe.

A method 17 can include elements of any of methods 1-16 and can include imaging the one or more detected defects in a respective pipe of the multi-pipe structure of method 13 using a set of four adjacent points in an image matrix to define an image value at each pixel.

A method 18 can include elements of any of methods 1-17 and can include the selected one or more visualizations of the pipes to include one or more three-dimensional plots of parameter values with respect to a radial direction or an azimuth or depth.

A method 19 can include elements of any of methods 1-18 and can include generating the one or more three-dimensional plots of method 18 to include plotting the parameter values in a colored wireframe mesh.

A method 20 can include elements of any of methods 1-19 and can include generating the one or more visualizations to include generating images of the pipes in a color or shading different from a color generated for walls of the pipes.

A method 21 can include elements of any of methods 1-20 and can include generating the one or more visualizations to include generating images of the pipes of method 20 in a color or shading for each pipe different from color or shading for the other pipes of the multi-pipe structure.

A method 22 can include elements of any of methods 1-21 and can include analyzing data associated with the one or more visualizations of the pipes and generating an action plan to remediate the multi-pipe structure based on the analysis.

A machine-readable storage device 1 having instructions stored thereon, which, when executed by one or more processors of a machine, cause the machine to perform operations, the operations comprising: acquiring responses from signals received from pipes of a multi-pipe structure in response to transmission of a probe signal from a transmitter operatively disposed within the multi-pipe structure; processing the responses to determine regions of equivalent metal loss in the pipes; and generating, in response to processing the responses, one or more visualizations of the pipes, including one or more detected defects, based on the responses or on results from an inversion operation on the responses, the one or more visualizations selected from a group of visualizations including a plot of top-view cross section images of one or more pipes correlated to a position of a set of positions along an axial direction, a plot as images with respect to frequency or time and depth, a set of plots of images with each plot being an image of a different pipe along the axial and azimuthal directions for each pipe, and one or more three-dimensional plots of parameter values with respect to a radial direction or an azimuth or depth.

A machine-readable storage device 2 can include structure of machine-readable storage device 1 and can include operations to conduct any one of the methods of methods 2-21.

A machine-readable storage device 3 can include structure of machine-readable storage device 1 or 2 and can include operations to control a source to generate the probe signal and to control a receiver to receive the signals from the pipes, the source and receiver arranged to operate from within the multi-pipe structure.

A machine-readable storage device 4 can include structure of any of machine-readable storage device 1-3 and can include operations to control the receiver structured as an azimuthally distributed sensor array.

A system 1 can comprise: one or more processors; a memory module operable with the one or more processors, wherein the one or more processors and the memory module are structured to operate to: acquire responses from signals received from pipes of a multi-pipe structure in response to transmission of a probe signal from a transmitter operatively disposed within the multi-pipe structure; process the responses to determine regions of equivalent metal loss in the pipes; and generate, in response to processing the responses, one or more visualizations of the pipes, including one or more detected defects, based on the responses or on results from an inversion operation on the responses, the one or more visualizations selected from a group of visualizations including a plot of top-view cross section images of one or more pipes correlated to a position of a set of positions along an axial direction, a plot as images with respect to frequency or time and depth, a set of plots of images with each plot being an image of a different pipe along the axial and azimuthal directions for each pipe, and one or more three-dimensional plots of parameter values with respect to a radial direction or an azimuth or depth; and a display to display the visualization.

A system 2 can include structure of system 1 and can include a user interface operable with the one or more processors to generate and control the visualization.

A system 3 can include structure of any of systems 1-2 and can include a source to generate the probe signal and a receiver to receive the signals from the pipes, the source and receiver arranged to operate from within the multi-pipe structure.

A system 4 can include structure of any of systems 3 and can include the receiver to include an azimuthally distributed sensor array or an azimuthally symmetric receiver.

In various embodiments, one or more methods as taught herein can be implemented to visualize the inspection results for multiple pipes in cased boreholes. These methods can provide details of the pipes along axial, azimuthal, and radial directions. The capability of resolving defects on separate casings and also imaging defects on each casing in more details facilitates a rapid and clear understanding of the situation and the proper remedial actions for the casings. Analysis of casing condition is an important objective, as tubing/casing removal is both expensive and time consuming, particularly in offshore platforms. Detailed images of these components will allow for better interpretation of the integrity of the casings which in turn leads to significant technical and financial enhancements during the production process.

Although specific embodiments have been illustrated and described herein, it will be appreciated by those of ordinary skill in the art that any arrangement that is calculated to achieve the same purpose may be substituted for the specific embodiments shown. Various embodiments use permutations and/or combinations of embodiments described herein. It is to be understood that the above description is intended to be illustrative, and not restrictive, and that the phraseology or terminology employed herein is for the purpose of description. Combinations of the above embodiments and other embodiments will be apparent to those of skill in the art upon studying the above description.

1. A method comprising:
acquiring responses from signals received from pipes of a multi-pipe structure in response to transmission of a probe signal from a transmitter operatively disposed within the multi-pipe structure;
processing the responses to determine regions of equivalent metal loss in the pipes; and
generating, in response to processing the responses, one or more visualizations of the pipes, including one or more detected defects, based on the responses or on results from an inversion operation on the responses, the one or more visualizations selected from a group of visualizations including a plot of top-view cross section images of one or more pipes correlated to a position of a set of positions along an axial direction, a plot as images with respect to frequency or time and depth, a set of plots of images with each plot being an image of a different pipe along the axial and azimuthal directions for each pipe, and one or more three-dimensional plots of parameter values with respect to a radial direction or an azimuth or depth.

2. The method of claim 1, wherein the multi-pipe structure is composed of three pipes.

3. The method of claim 1, wherein the multi-pipe structure is composed of four or more pipes.

4. The method of claim 1, wherein the responses are frequency domain responses with respect to amplitude, phase, attenuation, or phase difference.

5. The method of claim 1, wherein the responses are time domain responses with respect to amplitude or attenuation.

6. The method of claim 1, wherein the method includes plotting the inversion results as two-dimensional images showing the pipes and pipe features along two spatial directions.

7. The method of claim 1, wherein the method includes generating a visualization of the pipes as a plot of results of the inversion operation on the responses, in which dimensions of the pipes are estimated from the results of the inversion operation, with cross sections of walls of the pipes displayed on a two-dimensional plane along axial and radial directions with respect to an axis of the pipes.

8. The method of claim 1,
wherein the selected one or more visualizations of the pipes includes a plot of top-view cross section images of one or more pipes correlated to a position of a set of positions along an axial direction, and
wherein generating the top-view cross section images of the one or more pipes includes generating the top-view cross sections of the pipes as rings at selected depths with thickness of each ring representing thickness of each pipe and with the one or more detected defects shown on the rings with respective size and position obtained from the inversion operation.

9. (canceled)

10. The method of claim 1,
wherein the selected one or more visualizations of the pipes includes a plot as images with respect to frequency or time and depth,
wherein generating the plot as images with respect to frequency and depth includes computing images for each pipe based on a ratio or difference between acquired responses of a region of a defect of the respective pipe and acquired response of a region of non-defect of a respective pipe, implemented at each depth and over measurement frequencies, and
wherein the one or more detected defects are imaged as non-uniformities in background color or background grey scale levels.

11. (canceled)

12. (canceled)

13. The method of claim 1,
wherein the selected one or more visualizations of the pipes includes a set of plots of images with each plot being an image of a different pipe along the axial and azimuthal directions for each pipe,
wherein the images are constructed for each pipe separately or the images are merged into a single image with features of each pipe shown by a different color,
wherein each image is a two-dimensional image based on values of a ratio or a difference between the acquired response at a defected region and a non-defected region plotted in color-coded or grey scale format,
wherein the method includes
assigning, in each image of a different pipe, a color to the one or more detect defects in the respective pipe based on thickness of a non-defected region of the respective pipe; and
imaging the one or more detected defects in a respective pipe of the multi-pipe structure using a set of four adjacent points in an image matrix to define an image value at each pixel.

14. (canceled)

15. (canceled)

16. (canceled)

17. (canceled)

18. The method of claim 1,
wherein the selected one or more visualizations of the pipes includes one or more three-dimensional plots of parameter values with respect to a radial direction or an azimuth or depth, and
wherein generating the one or more three-dimensional plots includes plotting the parameter values in a colored wireframe mesh.

19. (canceled)

20. The method of claim 1, wherein generating the one or more visualizations includes
generating images of the pipes in a color or shading different from a color generated for walls of the pipes; and
generating images of the pipes in a color or shading for each pipe different from color or shading for the other pipes of the multi-pipe structure.

21. (canceled)

22. The method of claim 1, wherein the method includes analyzing data associated with the one or more visualizations of the pipes and generating an action plan to remediate the multi-pipe structure based on the analysis.

23. A machine-readable storage device having instructions stored thereon, which, when executed by one or more processors of a machine, cause the machine to perform operations, the operations comprising:
acquiring responses from signals received from pipes of a multi-pipe structure in response to transmission of a probe signal from a transmitter operatively disposed within the multi-pipe structure;
processing the responses to determine regions of equivalent metal loss in the pipes; and
generating, in response to processing the responses, one or more visualizations of the pipes, including one or more detected defects, based on the responses or on results from an inversion operation on the responses, the one or more visualizations selected from a group of visualizations including a plot of top-view cross section images of one or more pipes correlated to a position of a set of positions along an axial direction, a plot as images with respect to frequency or time and depth, a set of plots of images with each plot being an image of a different pipe along the axial and azimuthal directions for each pipe, and one or more three-dimensional plots of parameter values with respect to a radial direction or an azimuth or depth.

24. (canceled)

25. The machine-readable storage device of claim 23, wherein the operations include operations to control a source to generate the probe signal and to control a receiver to receive the signals from the pipes, the source and receiver arranged to operate from within the multi-pipe structure.

26. The machine-readable storage device of claim 23, wherein the operations include operations to control the receiver structured as an azimuthally distributed sensor array.

27. A system comprising:
a processor;
a machine-readable medium having program code executable by the processor to cause the processor to:
acquire responses from signals received from pipes of a multi-pipe structure in response to transmission of a probe signal from a transmitter operatively disposed within the multi-pipe structure;
process the responses to determine regions of equivalent metal loss in the pipes; and
generate, in response to processing the responses, one or more visualizations of the pipes, including one or more detected defects, based on the responses or on results from an inversion operation on the responses, the one or more visualizations selected from a group of visualizations including a plot of top-view cross section images of one or more pipes correlated to a position of a set of positions along an axial direction, a plot as images with respect to frequency or time and depth, a set of plots of images with each plot being an image of a different pipe along the axial and azimuthal directions for each pipe, and one or more three-dimensional plots of parameter values with respect to a radial direction or an azimuth or depth; and
a display to display the visualization.

28. The system of claim 27, wherein the system includes a user interface operable with the processor to generate and control the visualization.

29. The system of claim 27, wherein the system includes a source to generate the probe signal and a receiver to receive the signals from the pipes, the source and receiver arranged to operate from within the multi-pipe structure.

30. The system of claim 27, wherein the receiver includes an azimuthally distributed sensor array or an azimuthally symmetric receiver.
